(19) United States
(12) Patent Application Publication
(10) Pub. No.: US 2006/0179940 A1
(43) Pub. Date: Aug. 17, 2006

(54) Ultra-small Profile, Low Cost Chip Scale Accelerometers of Two and Three Axes Based on Wafer Level Packaging

(75) Inventors: Sheng Liu, Shanghai, MI (CN); Bin Chen, Canton, MI (US); Junjie Chen, Shanghai (CN); Jun Wei, Shanghai (CN); Xiaojun Wang, Shanghai (CN)

Correspondence Address: SHENG LIU, JUNJIA CHEN, BIN CHAN;FINEMEMS INC., RM 309, NO. 518 B, BIBO RD., ZHANGJIANG HI-TECH PARK, SHANGHAI, 201203, CN

(73) Assignee: FineMEMS INC., Shanghai (CN)

(21) Appl. No.: 10/906,269

(22) Filed: Feb. 11, 2005

(51) Int. Cl. G01P 15/00

(52) U.S. Cl. 73/488

(57) ABSTRACT

Several micro-machined, ultra-profile two-axis and three-axis accelerometers are fabricated by CMOS-compatible process, which makes them suitable for volume production. The x, y axis signal is based on natural thermal convection, and z-axis signal may be based on thermal convention or piezoresistive in nature. The bulk MEMS (Micro-Electro-Mechanical-Systems) process is based on Deep Reactive Ion Etching (DRIE). After the front-end fabrication process, the accelerometers are packaged at wafer level by glass frit and/or anodic bonding, which lowers the device cost.

### BACKGROUND OF THE INVENTION

Accelerometers have wide applications such as automobile air bags and suspension systems, computer hard disc drivers, LCD projectors, smart detonation systems for bombs and missiles and machine vibration monitors. A variety of mechanical and electrical devices are available for measuring acceleration such as piezoresistive and capacitive accelerometers. However, it is desirable to provide a highly sensitive accelerometer having a smaller size and lower cost than is available in these known accelerometers.

Most commercial accelerometers now are two-axis in nature. That is to say they can only measure the accelerations in the x-y plane of the sensor die. This is due to 2-dimensional limit of CMOS structures, and most commercial accelerometers use post-CMOS process for volume production. However, many applications require three-axis accelerometer, such as navigation guide, hard disc driver protection, cell phone, military products, side air bags, vehicle control, etc. Customers have been using daughter board for this purpose. However it adds expense to their often cost-sensitive products. Currently available accelerometers are in the range of 5 mm×5 mm×1.8 mm (Kionix). All the commercial accelerometers are packaging by over-molded plastic packaging (Motorola, Kionix), ceramic packaging (ADI and MEMSIC), and Dual-flat-no-lead packaging (Kionix), which are still big in size. For consumable products applications, it is highly desirable to develop accelerometers with even small profile having thickness around 1 mm or less and lateral dimensions, as size and power limitations, and low cost are key requirements. There exists a need for developing novel technology and associated accelerometers.

The present invention provides several alternatives for new accelerometers, including potentially lowest cost two-axis accelerometers with final output interconnects by wire bonding and vertical micro via based flip-chip interconnects, two three-axis accelerometers with a hybrid thermal convection/piezoresistive principle, and pure thermal convection coupled with four-layer wafer bonding process. In addition, the small sensor signal is amplified to large enough for the customer easy to use. The whole process is post-IC and CMOS-compatible, which makes it very suitable for volume production. The heavier gas SF6 is used to achieve larger sensitivity. The chip is bonded at wafer level, which lowers the MEMS packaging cost and increases the reliability.

### BRIEF DESCRIPTIONS OF THE DRAWINGS

FIG. 1 shows a top view (FIG. 1a), front view (FIG. 1b and FIG. 1c), and fabrication of one embodiment of the present invention by a hybrid thermal-piezo-resistive principle based on a 2-layer wafer level packaging.

FIG. 2 shows the signal readout circuit. Thermal z axis signal readout circuit (FIG. 2a), thermal y axis signal readout circuit (FIG. 2b), piezo z axis signal readout circuit (FIG. 2c).

FIG. 3 shows the sensor location optimization out of physical modeling.

FIG. 4 shows the two embodiments for 2-layer wafer level package, (a) flip-chip form, (b) wire bond form.

FIG. 5 shows the three-axis embodiment by a 4-layer wafer level packaging.

FIG. 6 shows the layout of every 4-layer wafer in 4-layer wafer level packaging.

### DETAILED DESCRIPTION OF THE INVENTION

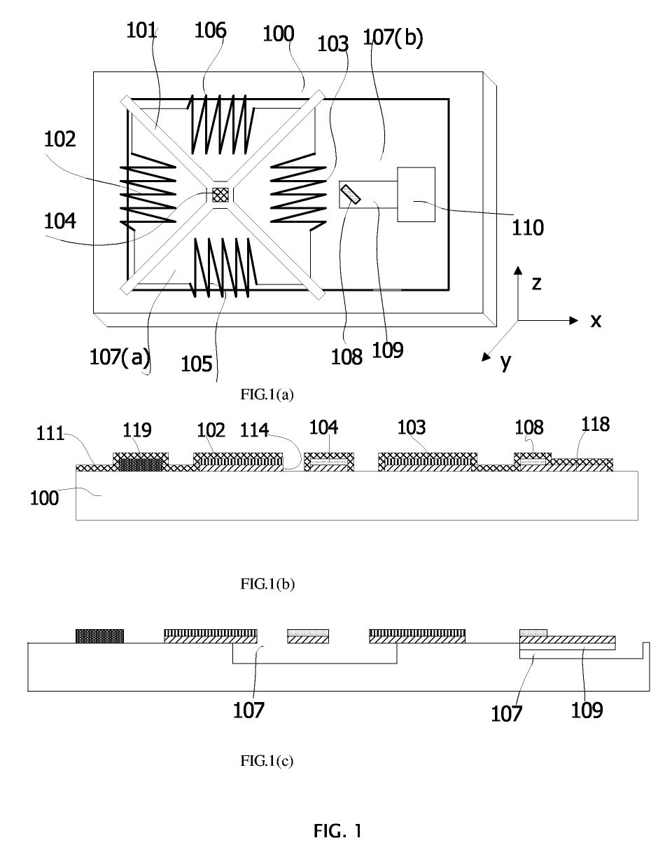

Referring to FIG. 1(a), the accelerometer is formed on a silicon substrate 100 in which a cavity 107 is formed underneath a heater 104 and thermopiles 102,103,105,106. The thermopiles arranged in two orthogonal directions are thermopiles with each thermopile in one pair at a distance of about x/D=0.2 to achieve larger sensitivity. The heater 104 is implemented using four short resisters made of polysilicon arranged in a small square. The heater 104 and two pairs of thermopiles are all suspended above the cavity 107 with four metal bridges 101 formed by aluminum. Electrical current passing through the heater 104 via the four-bridge connection to external power source, and then the temperature of the gas around the heater is increased and temperature gradient is established. “T-shape” distribution proof mass 110 is also above another cavity, with beam 109 and piezoresistor 108 comprising a z-axis accelerometer. When z-axis acceleration is applied on the sensor, the beam will bend along the axis-direction, which leads to the resistor difference of piezoresistor 15. Then z-axis acceleration signal can be extracted from the piezoresistor. The orientation of 45 degrees and location at the center of the edge of the beam maximizes the sensitivity to shear stress and the shear stress being sensed by the transducer by maximizing the piezoresistive coefficient.

FIG. 1(b) is the cross section after CMOS process. CMOS-compatible process is developed to recduce the fabrication cost. After CMOS process is finished, the substrate 100 is bulk micromachined. The cavity 107a and cavity 107b supply the space for the natural convection of the hot gas bubble and the vibration of the beam. The larger the cavity is, the larger the sensitivity is. At the same time, this will increase the die size and the cost per device. The cavity 107a and cavity 107b are etched by Deep Reactive Ion Etching (DRIE), such as SCREAM, which stands for Single-Crystal-Silicon-Reactive Etching and Metallization. Photo resistor 111 is coated on the rest of the die except the cavity area. Because the signal conditioning circuit 102 has been fabricated during CMOS process on the same die, it is also covered by photo resistor. Thermopiles 102 and 103 are fabricated on protection SiO2 layer 114.

FIG. 1(c) is the cross section after MEMS process. After DRIE process, the photo resistor is striped off by oxygen plasma. The thickness of beam 109 is optimized. There is a trade off between sensor sensitivity and etching process.

Sensor parameter optimization is very important to its performance. The hot gas bubble in the sealed cavity is SF6 or CO2. The sensor sensitivity is proportional to the gas convection intension. The natural free convection intension is expressed by Rayleigh number, and Rayleigh number is the product of Grashshof number and Prandtl number. Therefore, we obtain:

$$Ra = Gr Pr = \frac{{c}_{p} {ρ}^{2} β a Δ T {L}^{3}}{μ λ}$$

where Ra is Rayleigh number, Gr is Grashshof number, and Pr is Prandtl number, C_{P} is the specific heat of the gas, ρ is the density, β is volume expansion coefficient, α is thermal diffusion coefficient, ΔT is the temperature difference between the thermopile, L is the cavity length, μ is dynamic viscosity, and λ is thermal conductivity coefficient.

A simple way to obtain a larger Ra is to use a heavy gas, and SF6, which is widely used in semiconductor industry, is not toxic. Therefore, the gas used for the hot bubble may be CO2 or SF6 here to achieve larger sensitivity.

With the two pairs of thermopiles having equal distance from the heater and no acceleration applied, the differential temperature between thermopile 18 and 20 are zero. Take y-axis for example. When acceleration is applied, the change in convective flow causes a temperature difference in each pair of the thermopiles between sides of the heater 13, then temperature gradient shifts. The temperature difference due to y-axis acceleration is proportional to the applied acceleration, and according to our research, the convective accelerometer can achieve good linearity when the Grashof number ranges from 10⁻² to 10⁻³. The principle of x-axis is the same as that of y-axis. Moreover, we can also obtain the z-axis acceleration with the current structure.

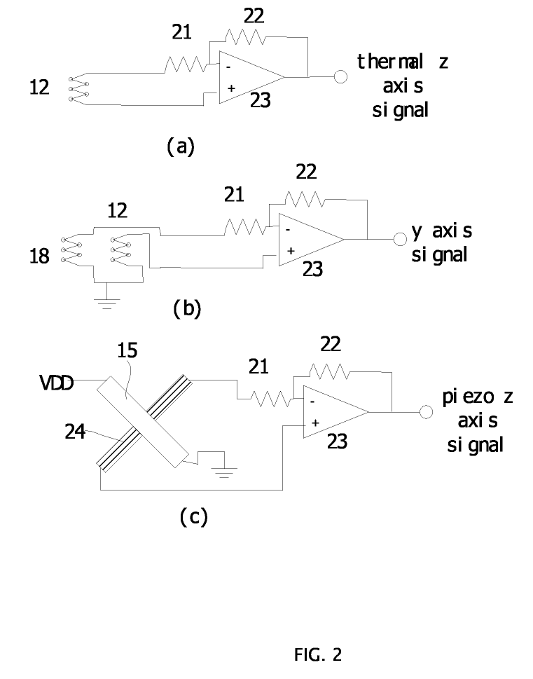

Due to two-dimensional limit of CMOS structures, current thermal accelerometer can only provide sensitivity in x and y directions. However, the isothermal contours are not vertically (z-axis) symmetrical. Every thermopile has a hot junction and cold junction, hot junction is closer to the heater than the cold junction. Thermal gradient at the point of hot junction displays a vertical component, whose amplitude depends on the thermal asymmetry in vertical direction as well as position of hot junctions. The trench depth and the package height will influence the thermal asymmetry in vertical direction. The inventors use the common mode voltage of the thermocouple to extract the z-axis acceleration signal, as can be seen in the FIG. 2.

FIG. 2(a) shows the thermal z-axis signal readout circuit. The common mode signal is used to extract the z-axis signal. So the output of the die-plane thermopile are input to an operational amplifier 23. The operational amplifier has an input resistor 21 and a feedback resistor 22, the two resistors. These two resistors value decide the gain of the amplifier. Actually, the resistor value can be laser trimmed to refine the signal conditioning.

FIG. 2(b) shows the y-axis signal readout circuit. The y-axis thermopiles 12 and 18's cold junctions are connected to the circuit ground, and the differential signal are connected to an operational amplifier. The amplifier circuit is the same as FIG. 2(a). The x-axis signal is similar to that in FIG. 2(b). The difference is to change the y-axis thermopiles to x-axis thermopiles. However, this z-axis signal's sensitivity is smaller than the sensitivity of x and axes. This can be compensated for by the amplifier circuit.

Another embodiment of z-axis signal is shown in FIG. 2(c). The orientation of the piezoresistor 15 in 45 degrees and is located at the center of the edge of the beam maximizes the sensitivity to shear stress and the shear stress being sensed by the transducer by maximizing the piezoresistive coefficient. The single piezoresistor is used to sense the strain that occurs when z-axis acceleration is applied on the die, which will lead to a differential voltage on the the voltage taps 24 connected to the piezoresistor. The differential signal is amplified using a similar circuit shown in FIG. 2(a).

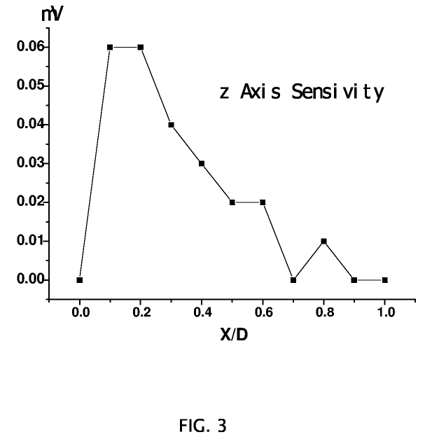

FIG. 3 is the sensor test data of the thermal z-axis signal with different thermopiles distance, where x is the distance from the hot junction to the heater, and D is the cavity size. Sensitivity is very important for the customer to use the accelerometer. From the test data, when x/D=0.2, we can obtain the maximum sensitivity.

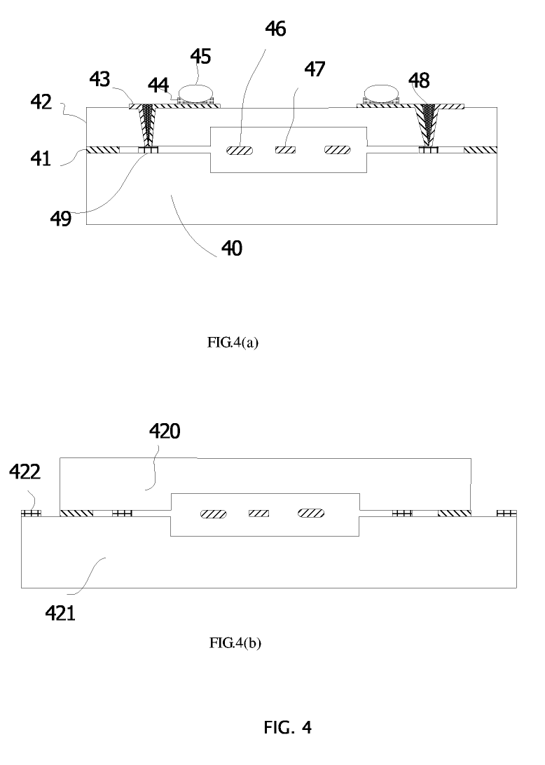

FIG. 4(a) is the cross section view of the accelerometer package for flip-chip interconnect to the external board. Packaging at wafer level can reduce device size and the cost. Here, the three-axis accelerometer is packaged on wafer level. The sensor wafer 40 and the cover wafer 42 are mated together by glass frit 41. The cap wafer 42 is glass, such as Pyrex 7740. The glass wafer is etched by KOH forming a round cavity for the air convection. 47 is the heater of the thermal accelerometer, and thermopile 46 is used to sense the temperature difference. To supply enough space for the air bubble, the sensor wafer is also etched with a depth of about 300 um with DRIE. The glass frit used here has a thermal coefficient of expansion similar to that of silicon, therefore, there will be no major thermal mismatch between chip and package. Thermal accelerometer is therefore in chip-scale, low-cost and with high reliability. In this way, the introduced stress in the accelerometer is very small. Glass frit 41 was applied on the sensor wafer using a screen printer, with a height of about 25 um thick, the height is a little higher than the Al pad 49 on the sensor wafer. Then the two wafers are bonded together at a temperature of 400C. The electrical signals come out from the vias on the glass cap wafer, which are made by sputtering with Al 43. The etching process of vias are made in KOH solution. The under-bump metallurgy (UBM) 44 consists of Ti—W and Cu. The UBM and solder bump 45 are fabricated by electroplating. After the wafer level package, the accelerometer can be mounted on the print circuit board by flip-chip bonding to reduce the cost and chip size.

FIG. 4(b) is the cross section view of the accelerometer package for wire bond. Cap wafer 420 and sensor wafer 421 are also bonded together by glass frit. However, the electrical signal does not go out through the cap wafer, the out pad 422 is fabricated on the sensor wafer for wire bond. This package form can eliminate the vias on the cap wafer, probably producing the lowest cost two-axis accelerometer.

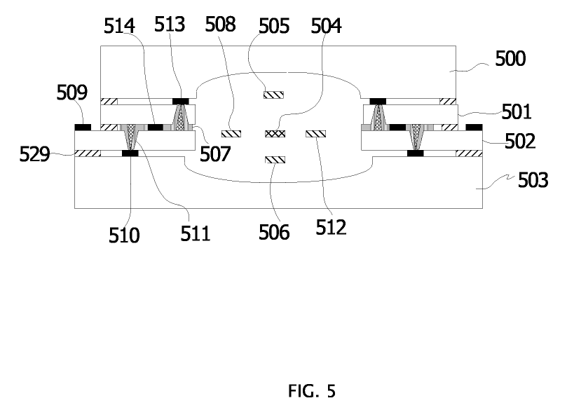

FIG. 5 is the three-axis accelerometer. This accelerometer is also packaged at wafer level to reduce both size and cost. It is made up with 4-layer wafers stacked together. The cap wafer 500 is silicon or glass wafer, with a thermopile 505. The bottom wafer 503 is also bulk etched as cap wafer 500. The thermopiles on the cap wafer and bottom wafer will generate a differential signal when Z axis (vertical to the die plane) acceleration is applied on the sensor. Main silicon wafer 502 is fabricated by CMOS compatible technology. After CMOS process for the thermopiles and heater, the wafer is front etched by DRIE. The cavity is etched for the air convection in the closed chamber. Vias on the intermediate wafer 501 are also dry etched for signal interconnections between the Al pad 513 on the cap wafer 500 and the Al pad on 514 on the main wafer 502. The electrical signals come through the vias on the intermediate wafer 502, which are made by sputtering with Al 507. Glass frit 529 is applied on the wafers using a screen printer, with a height of about 25 um thick, and the height is a little higher than the Al pad on the wafers. Then the four layer wafers are bonded together at a temperature of 400C for hermetical seal. At last, signals are connected to out pad 509 for next level package. Optionally, top glass and bottom glass can be bonded anodically to the silicon next to them. Other methods such as induction heating, laser bonding, and microheater induced bonding, plasma activated low temperature bonding, after they are developed into mature technology, will also be used for these wafers.

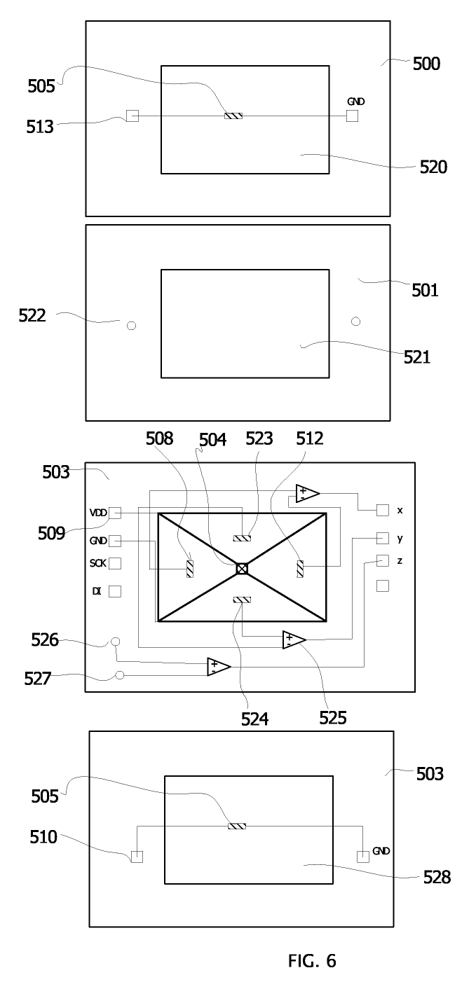

FIG. 6 shows the layout of the four wafers. Thermopile 505 is suspended over the cavity 520 etched by DRIE. The positive z-axis signal comes through Al pad 513 to the lower wafer 501. The positive z-axis signal comes through via 522 on the intermediate wafer 501. This wafer is through etched. The main wafer 503 is also through etched. Al Pads 509 on the wafer include VDD, GND, which are for power supply; SCK, DI is used for trimming or testing the device; x,y, z pads are the output acceleration signal for the three axes. The x-axis differential signal from thermopiles 508 and 512 is amplified by operational amplifier 525. The y-axis signal comes from thermopiles 523 and 524. Vias 526 and 527 represent positive z-axis signal and negative z-axis signal respectively, this differential signal is amplified similarly. The bottom wafer 503 is similar to the cap wafer 500, negative z-axis signal pad 510 goes through via 527 to the main wafer 503.

While the present invention has been particularly shown here and described with reference to exemplary embodiments thereof, it will be understood by those of ordinary skills in the art that various changes in form and details may be made therein without departing from the spirit and scope of the present invention as defined by the following claims.

What is claimed is:

1. A two-axis accelerometer, which includes a heater, hot gas bubble, thermopiles, and cavity beneath.

2. The accelerometer in claim 1 can measure acceleration in three axes, x, and y. Signals from x, y axes are based on thermal natural convection.

3. The material for heater in claim 1 is polysilicon; the materials for thermopiles are polysilicon and Al, which can be deposited by CMOS process. There are a hot junction and a cold junction for each thermopile. They use Seeback effect to convert temperature difference to voltage signal.

4. Interconnects or feedthrough in claim 1 to the board level assembly can be by a wire bonding form or flip-chip form.

5. A three-axis accelerometer, which includes a heater, hot gas bubble, thermopiles, a beam distribution proof mass and piezoresistor and cavity beneath.

6. The accelerometer in claim 5 can measure acceleration in three axes, x, y, and z axis. Signals from x, y axes are based on thermal natural convection. Z-axis signal is based on thermal or piezoresistive in nature.

7. The material for heater in claim 5 is polysilicon; the materials for thermopiles are polysilicon and Al, which can be deposited by CMOS process. There are a hot junction and a cold junction for each thermopile. They use Seeback effect to convert temperature difference to voltage signal.

8. The beam, distribution proof mass and piezoresistor in claim 5 and claim 1 comprise a z-axis (vertical to the plane of the die) accelerometer, the z-axis signal is extracted from the piezoresistor when z-axis acceleration is applied on the accelerometer.

9. The z-axis in claim 5 may also be based on thermal convection, which can be extracted from the common mode voltage of the thermopiles in claim 1.

10. The hot gas bubble in claim 5 and claim 1 may be CO2 or SF6 to achieve a larger sensitivity, and the hot gas bubble is packaged by hermetic seal.

11. The cavity in claim 5 and claim 1 is etched by Deep Reactive Ion Etching (DRIE). The cavity supplies the space for the natural convection of the hot gas bubble in claim 5 and claim 1 and the vibration of the beam in claim 5.

12. Acceleration signals in x and y axes in claim 5 are extracted from the differential voltage of each thermopile. The differential voltage is proportional to the acceleration applied on the axis along thermopile-heater-thermopile.

13. The hermetic seal in claim 11 is packaged at wafer level by a glass cap wafer using glass frit as intermediate layer to compromise the monolithic integration with the application specific integrated circuits (ASIC).

14. The glass cap wafer in claim 11 is etched by KOH resolution to form one cavity or two cavities at the center of the die. The cavities are also for gas convection and vibration of the beam. Under-bump metallurgy (UBM) and solder bumps are electroplated on the cap wafer for flip-chip bonding.

15. Vias through the cap wafer in claim 10 supply the signal interconnections between the sensor wafer and the cap wafer, vias are by Al sputtering.

16. Another embodiment in claim 13 is also packaged at wafer level with glass frit as intermediate layer. The cap wafer seals the sensor wafer hermetically. Electrical signal comes out on the sensor wafer, this method is for wire bonding.

17. The accelerometer in claim 5 has another embodiment, where it is packaged in three dimensions, with four wafers stacked together, the cap wafer and the bottom wafer are glass and the other two are silicon wafers.

18. The cap wafer in claim 17 is fabricated with a thermopile suspended on a cavity, the thermopile is used to sense positive z- axis signal. The wafer is etched in KOH resolution.

19. The bottom wafer in claim 13 is fabricated with a thermopile suspended on a cavity, the thermopile is used to sense negative z-axis signal. The wafer is also etched in KOH resolution.
